(19) United States
(12) Patent Application Publication
(10) Pub. No.: US 2023/0235866 A1
(43) Pub. Date: Jul. 27, 2023

(54) LED CEILING FRAME LIGHT CONFIGURED FOR MOUNTING WITH A CEILING SUPPORT GRID AND METHOD OF INSTALLATION

(71) Applicant: Litetronics International, Inc., Bedford Park, IL (US)

(72) Inventors: Robert Sorensen, Bedford Park, IL (US); Raghu Rao, Romeoville, IL (US)

(21) Appl. No.: 17/586,141

(22) Filed: Jan. 27, 2022

(51) Int. Cl. F21S 8/04; F21V 21/03

(52) U.S. Cl. CPC F21S 8/043; F21V 21/03; F21Y 2115/10

(57) ABSTRACT

Technologies are described for an LED ceiling frame light configured to be mounted with a ceiling support grid. The LED ceiling frame light has a rectangular or square configuration with outwardly extending flanges configured and disposed to lay on inwardly extending flanges on the ceiling support grid. At least two connectors are configured and disposed to removably connect legs, or portions of the LED ceiling frame light, together and form the LED ceiling frame light into a rectangular or square shape with a rectangular or square opening.

### FIELD OF THE DISCLOSURE

This invention generally relates to an LED ceiling frame light configured to be mounted with a ceiling support grid ceiling, such as a false ceiling having ceiling tiles supported with a ceiling support grid.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Ceiling support grids and ceiling panels are very common in the office buildings where ceilings are constructed over open floor plan interior designs, such as cubicles. Such ceiling are popular in other commercial, industrial and domestic environments, including and not limited to hotels, meeting rooms, recreation rooms and other types of rooms or constructions which require removable ceilings for access to utilities (heating, air conditioning, water) that are concealed in the space between the drop ceiling tiles and the structural ceiling of the room. Such ceiling systems are well suited for use in old office buildings with high ceilings and with ceilings that are curved or arched. Typically, ceiling panels may be installed from beneath the ceiling support grid.

Typical luminaires installed in ceiling support grids may have a troffer or otherwise have a configuration proximate a ceiling tile which they may replace. These large rectangular or square luminaires are typically placed on the ceiling support grid to have the light from the lamps directed downward through a space in the ceiling support grid having a ceiling panel removed.

The warehousing space requirements and shipping costs for the typical luminaries may be substantial. It may be desired to have a luminaire configured for mounting with a ceiling support grid that reduces storage and shipping costs associated therewith.

### SUMMARY

In at least one embodiment of the present disclosure, an LED ceiling frame light configured to be mounted with a ceiling support grid is provided. The ceiling support grid comprises at least one rectangular or square grid opening with a first longitudinal flange extending inward from a first side, a second longitudinal flange extending inward from a second side, a third longitudinal flange extending inward from a third side, and a fourth longitudinal flange extending inward from a fourth side, wherein the first flange is parallel with the third flange and the second flange is parallel with the fourth flange. The LED ceiling frame light comprises a first leg having at least one longitudinal extending LED light strip and a flange configured and disposed for laying on the first flange of the ceiling support grid, a second leg having at least one longitudinal extending LED light strip and a flange configured and disposed for laying on the second flange of the ceiling support grid, a third leg having at least one longitudinal extending LED light strip and a flange configured and disposed for laying on the third flange of the ceiling support grid, and a fourth leg having at least one longitudinal extending LED light strip and a flange configured and disposed for laying on the fourth flange of the ceiling support grid. At least two connectors are configured and disposed to connect the first leg, the second leg, the third leg, and the fourth leg together and form the LED ceiling frame light into a rectangular or square shape with a rectangular or square opening. Upon connecting the at least two connectors together, the formed rectangular or square LED ceiling frame light is configured to be held in the rectangular or square grid opening with the first, the second, the third, and the fourth longitudinal extending flanges of the ceiling support grid.

In at least one other embodiment of the present disclosure, a method of mounting an LED ceiling frame light with a ceiling support grid is provided. The method comprises removing a ceiling tile from the ceiling support grid and forming a rectangular or square grid opening therein. At least two connectors are connected together to form the LED ceiling frame light to have a first leg, a second leg, a third leg, and a fourth leg with a rectangular or square opening. Flanges extending outwardly from the legs of the LED ceiling frame light are laid on ceiling support grid flanges extending inwardly toward the rectangular or square grid opening, holding the LED ceiling frame light in the rectangular or square grid opening. The LED ceiling frame light is electrically connected with a power source and the removed ceiling tile, or other ceiling tile or feature, is laid on the legs of the LED ceiling frame light, covering the rectangular or square opening in the LED ceiling frame light.

### BRIEF DESCRIPTIONS OF THE DRAWINGS

The foregoing and other features of this disclosure will become more fully apparent from the following description and appended claims, taken in conjunction with the accompanying drawings and examples. Understanding that these drawings depict only several embodiments in accordance with the disclosure and are, therefore, not to be considered limiting of its scope, the disclosure will be described with additional specificity and detail through use of the following figures, which are idealized, are not to scale and are intended to be merely illustrative of aspects of the present disclosure and non-limiting. In the drawings, like elements are depicted by like reference numerals. The drawings are briefly described as follows:

FIG. 1 is a perspective view of the LED ceiling frame light of the present disclosure mounted with a ceiling support grid;

FIG. 2 is a perspective view of the LED ceiling frame light shown in FIG. 1;

FIG. 2a is an upper and lower perspective view of corner portions of the LED ceiling frame light shown in FIG. 2, showing an example placement of a connector and electrical lines;

FIG. 3 is a perspective view of the LED ceiling frame light of the present disclosure showing an illustrative example of the LED ceiling frame light of the present disclosure having disconnected legs;

FIG. 3a shows perspective cut-away views of an illustrative connector of the LED ceiling frame light shown in FIG. 3;

FIG. 4 illustratively shows selected component parts of the presently disclosed LED ceiling frame light having at least one connector; and

FIG. 5 is a view of an LED lighting system having the LED ceiling frame light shown in FIG. 1 and an electrical junction box held to the ceiling support grid.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the FIGs, can be arranged, substituted, combined, separated, and designed in a wide variety of different configurations, all of which are explicitly contemplated herein.

This present disclosure provides a LED ceiling frame light configured to be held with a ceiling support grid. The LED ceiling frame light has a rectangle or square light emitting surface with a central opening. There are at least two connectors in the LED ceiling frame light, allowing the LED ceiling frame light to be disconnected into at least two portions or legs. Upon disconnecting the connectors and separating the LED ceiling frame light into two or more sections or legs, the legs or sections may be arranged to reduce its size for packaging and/or shipping. For example, in an embodiment having two connectors, the LED ceiling frame light may be separated in half and the halves may be stacked for packing. The reduction in packaging size may reduce packaging and/or shipping costs.

Upon the sections or legs being connected, the LED ceiling frame light has outwardly extending flanges configured and disposed for laying on inwardly extending flanges on the ceiling support grid. The LED ceiling frame light may be easily installed and held to the ceiling support grid by simply laying it on the ceiling support grid flanges. The assembled LED ceiling frame light has a rectangular or square formation with a central opening, which may also be rectangular or square. Upon installing the LED ceiling frame light in the ceiling support grid, a ceiling panel or other feature may be laid on top of the LED ceiling frame light for covering the opening in the LED ceiling frame light. For example, a ceiling panel may be removed; a frame light may be installed in the formed opening in the ceiling support grid; and the removed ceiling panel may then be installed on the LED ceiling frame light.

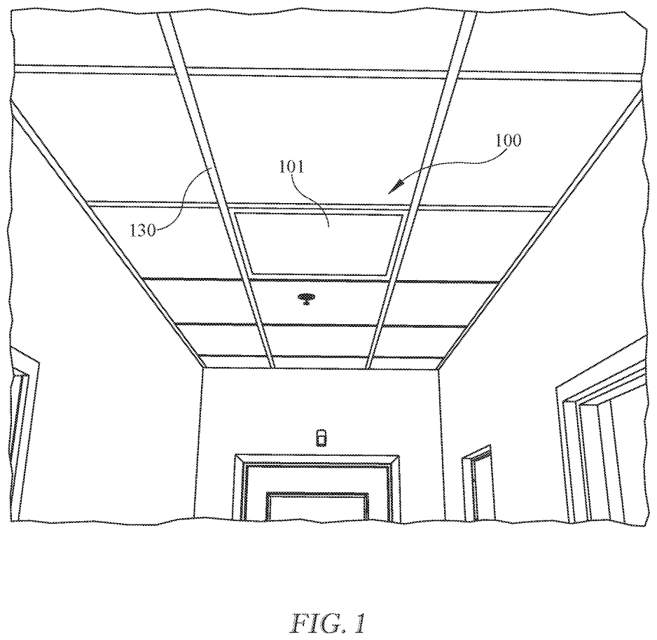

FIG. 1 is a perspective view of LED ceiling frame light 100 mounted with ceiling support grid 130. Ceiling panel 101 is mounted on LED ceiling frame light 100 and covers a rectangular or square opening in LED ceiling frame light 100. Ceiling panel 101 may be the ceiling panel that was removed for the installation of LED ceiling frame light 100, or may be a different ceiling panel or feature. For example, ceiling panel 101 may have a decorative scene, such as clouds in the sky. The light emitting portion of LED ceiling frame light 100 may be configured to cast light onto ceiling panel 101.

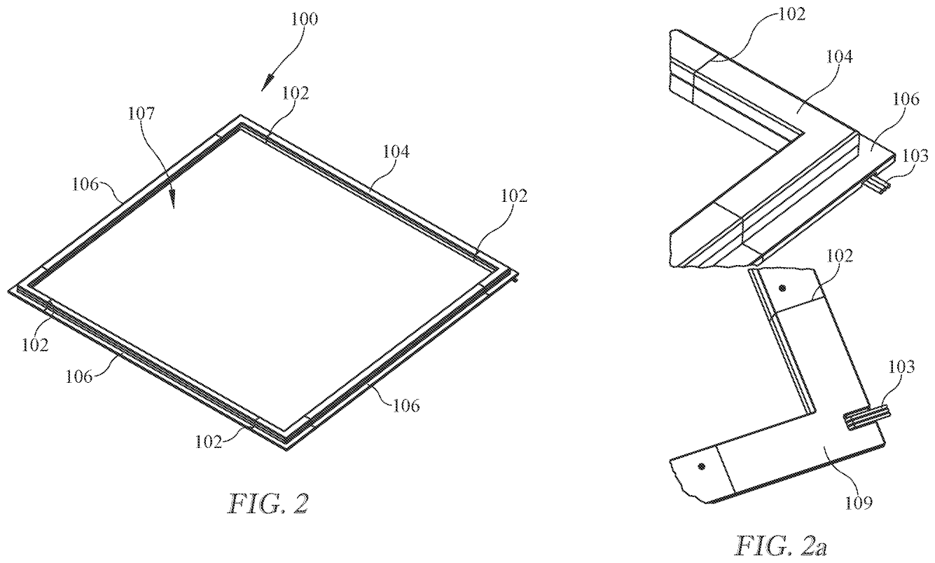

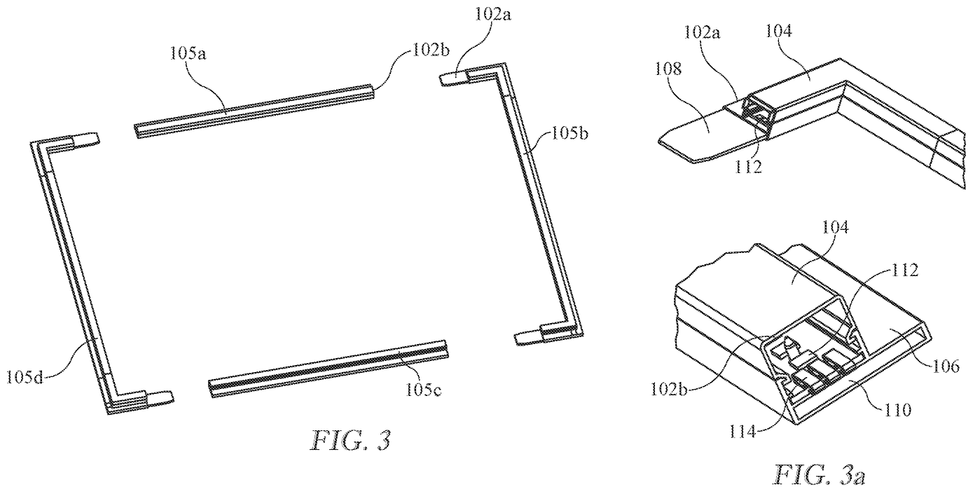

FIG. 2 is a perspective view of the LED ceiling frame light 100 and FIG. 2a is an upper and lower perspective view of corner portions of LED ceiling frame light 100. FIG. 3 is a perspective view of LED ceiling frame light 100 showing disconnected legs or portions. LED ceiling frame light 100 has a first leg 105a, a second leg 105b, a third leg 105c, and a fourth leg 105d. Each of the legs has a longitudinal extending light transmissive surface 104 and a flange 106 configured and disposed for laying on a ceiling support grid flange. LED ceiling frame light 100 has at least two connectors 102 configured and disposed to connect the first leg 105a, the second leg 105b, the third leg 105c, and the fourth leg 105d together and form the LED ceiling frame light into a rectangular or square shape with a rectangular or square opening 107, as shown in FIG. 2. It is to be understood that LED ceiling frame light 100 may have as few as two connectors 102, configuring LED ceiling frame light 100 to be separable into two sections or legs.

In at least embodiment, LED ceiling frame light 100 has a light transmissive cover or lens 104 covering each of the longitudinal extending LED light strips. For example, light transmissive cover or lens 104 may have a light diffuser configured and disposed to diffuse light from individual LEDs in the LED light strips and provide an appearance of a substantially continuous light source. In at least one other embodiment, LED ceiling frame light 100 is configured and disposed to direct a portion of light emitted by the longitudinal extending LED light strips 112 toward rectangular or square opening 107 in LED ceiling frame light 100.

The rectangular or square formed LED ceiling frame light 100 may be separable into individual legs or sections, as illustratively shown in FIG. 3. For example, each leg or section may have a portion of a connector, 102a and 102b, at its longitudinal ends. The individual legs or sections 105a, 105b, 105c, 105d may be arranged in a desired configuration for packaging, storing, and/or shipping. The desired configuration may be such that the volume of the LED ceiling frame light legs is significantly less than that of the rectangular or square formation of LED ceiling frame light 100, which may in turn reduce packaging, storing, and/or shipping costs. Upon a being shipped to a user, legs or sections 105a, 105b, 105c, 105d may be readily connected with connectors 102 to form the rectangular or square shaped LED ceiling frame light 100, as shown in FIG. 2. Upon connecting the at least two connectors 102 together, the formed rectangular or square LED ceiling frame light 100 is configured to be held in a rectangular or square grid opening and may be readily mounted with, or installed in, ceiling support grid 130.

FIG. 2a shows an upper and lower perspective view of corner portions of the LED ceiling frame light 100 showing an example placement of connector 102 and electrical lines 103. LED ceiling frame light 100 may have a connector 102 proximate, or at, a corner. Electrical lines 103 may extend from LED ceiling frame light 100 at a position to eliminate, or substantially minimize, any interference with a ceiling panel or other feature to be installed therewith. For example, LED ceiling frame light 100 may have a substantially planar surface 109 configured for laying a ceiling panel or other feature thereon to cover the rectangular or square opening in LED ceiling frame light 100, upon installing with ceiling support grid 130.

FIG. 3a shows perspective cut-away views of an illustrative connector 102 of the LED ceiling frame light 100. Connectors 102 may have a first portion 102a and a second portion 102b. First portion 102a may have an extension 108 configured and disposed to be received with an opening 110, in second portion 102b. An electrical contact 114 may be disposed in one of the connector portions, 102a or 102b. Electrical contact 114 is configured and disposed to electrically connect longitudinal extending LED light strips 112 together, upon connection first portion 102a with second portion 102b.

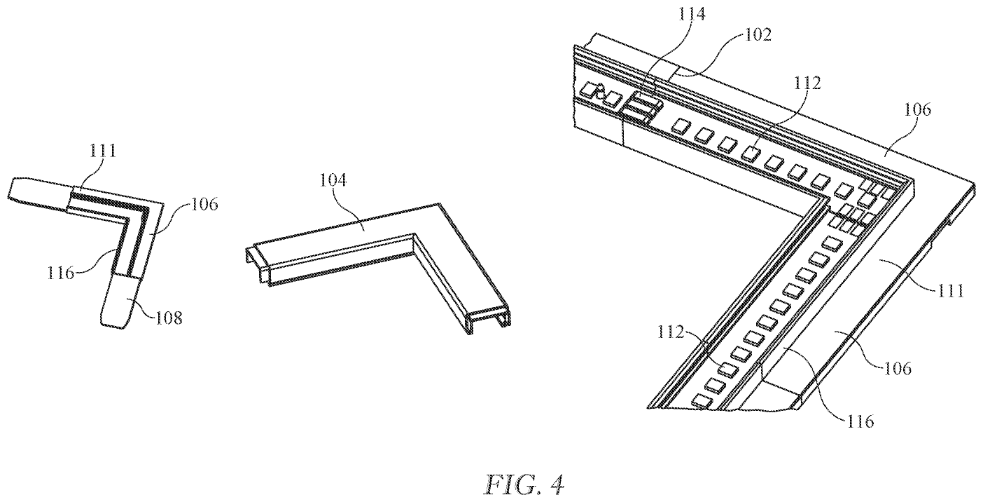

FIG. 4 illustratively shows selected component parts of LED ceiling frame light 100 having at least one connector portion. LED ceiling frame light 100 may have a light transmissible cover or lens 104 adapted to fit with a base 111. For example, base 111 may have extensions 116 configured and disposed for snapping, or otherwise attaching, light transmissible cover or lens 104 to base 111. Base 111 may hold one or more LED longitudinal extending LED light strips 112. LED ceiling frame light 100 may have corner sections with a connector portion, 102a or 102b, at one end or two ends.

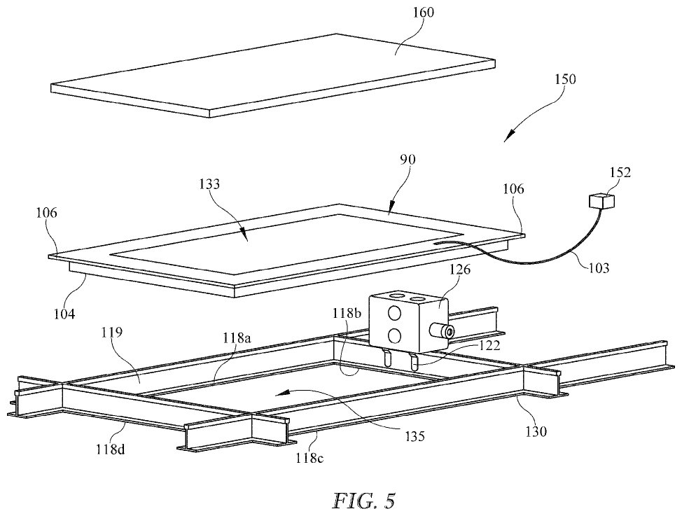

FIG. 5 is a view of an LED lighting system 150 having the LED ceiling frame light 100 and an electrical junction box 126 held to the ceiling support grid 130. Ceiling support grid 130 has least one rectangular or square grid opening 103 with a first longitudinal flange 118a extending inward from a first side, a second longitudinal flange 118b extending inward from a second side, a third longitudinal flange 118c extending inward from a third side, and a fourth longitudinal flange 118d extending inward from a fourth side, wherein the first flange is parallel with the third flange and the second flange is parallel with the fourth flange. Ceiling support grid 130 may have a “T” shaped cross section with upwardly extending flanges 119, extending upwardly from the inwardly extending flanges.

In at least one embodiment, LED ceiling frame light 100 has a first leg 105a having at least one longitudinal extending LED light strip 112 and a flange 106 configured and disposed for laying on a first flange 118a of the ceiling support grid 130, a second leg 105b having at least one longitudinal extending LED light strip 112 and a flange 106 configured and disposed for laying on a second flange 118b of the ceiling support grid 130, a third leg 105c having at least one longitudinal extending LED light strip 112 and a flange 106 configured and disposed for laying on a third flange 118c of ceiling support grid 130, and a fourth leg 105d having at least one longitudinal extending LED light strip 112 and a flange 106 configured and disposed for laying on a fourth flange 118d of ceiling support grid 130.

LED ceiling frame light 100 has at least two connectors 102 configured and disposed to connect the first leg, the second leg, the third leg, and the fourth leg together and form LED ceiling frame light into a rectangular or square shape with a rectangular or square opening 133.

LED lighting system 150 may have an electrical junction box 126 configured to be held to ceiling support grid 130 and house an electrical junction of LED ceiling frame light 100 to a power source. Clip 122 may be provided for connecting junction box 126 to ceiling support grid 130. For example, clip 122 may be configured and disposed to clip onto an upwardly extending flange 119 and support and hold electrical junction box 126 therewith. An LED driver and/or other light controls may be housed in electrical junction box 126. Electrical connector 152 may extend from a terminal end of electrical line 103 which may be adapted to plug into, or otherwise connect with, an LED driver.

LED lighting system 150 may have electronic driving circuit which may be configured to modulate the light output from LED ceiling frame light 100 to have different intensity and color, where the intensity and color may be independently controlled. LED lighting system 150 may have WiFi®, Bluetooth®, microwave, and/or IR connectivity for remote control.

LED ceiling frame light 100 may be installed or mounted with ceiling support grid 130 by removing a ceiling panel from the ceiling support grid and forming a rectangular or square opening therein; connecting at least two connectors together and forming an LED ceiling frame light having a first leg, a second leg, a third leg, and a fourth leg with a rectangular or square opening; laying flanges extending outwardly from the legs of the LED ceiling frame light on ceiling support grid flanges extending inwardly toward the rectangular or square opening in the ceiling support grid; and electrically connecting the LED ceiling frame light with a power source. The removed ceiling panel, or other ceiling panel or feature, may be laid on the legs of the LED ceiling frame light to cover the rectangular or square opening in the LED ceiling frame light. An electrical junction box may be attached to the ceiling support grid.

LED ceiling frame panel light 100 may be electrically connected to a power source and the electrical junctions may be housed in the electrical junction box. An LED driver may be housed in electrical junction box 126. Light intensity and color control circuitry may be placed in electrical communication with the driver, where the intensity and color may be independently controlled. LED lighting system 150 may have Wi-Fi, Bluetooth, microwave, and/or IR connectivity for remote control. One or more of the LED driver, control circuitry, and remote control circuitry may be housed in the junction box.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An LED ceiling frame light configured to be mounted with a ceiling support grid:
the ceiling support grid comprising at least one rectangular or square grid opening with a first longitudinal flange extending inward from a first side, a second longitudinal flange extending inward from a second side, a third longitudinal flange extending inward from a third side, and a fourth longitudinal flange extending inward from a fourth side, wherein the first flange is parallel with the third flange and the second flange is parallel with the fourth flange;
the LED ceiling frame light comprises:
a first leg having at least one longitudinal extending LED light strip and a flange configured and disposed for laying on the first flange of the ceiling support grid;
a second leg having at least one longitudinal extending LED light strip and a flange configured and disposed for laying on the second flange of the ceiling support grid;
a third leg having at least one longitudinal extending LED light strip and a flange configured and disposed for laying on the third flange of the ceiling support grid;
a fourth leg having at least one longitudinal extending LED light strip and a flange configured and disposed for laying on the fourth flange of the ceiling support grid;
at least two connectors configured and disposed to connect the first leg, the second leg, the third leg, and the fourth leg together and form the LED ceiling frame light into a rectangular or square shape with a rectangular or square opening;
wherein each of the legs and the connectors have a substantially planar upper surface configured for laying a ceiling panel or other feature thereon, to hold the ceiling panel or other feature substantially in a plane of adjacent ceiling panels held in the ceiling support grid, and to cover the rectangular or square opening in LED ceiling frame light; and
wherein, upon connecting the at least two connectors together, the formed rectangular or square LED ceiling frame light is configured to be held in the rectangular or square grid opening with the first, the second, the third, and the fourth inwardly longitudinal extending flanges of the ceiling support grid

2. (canceled)

3. The LED ceiling frame light of claim 1, wherein each of the connectors has an electrical contact configured and disposed to electrically connect each of the LED light strips together.

4. The LED ceiling frame light of claim 3 having a continuous uninterrupted light source, throughout its first, second, third, and fourth legs, upon the connecting of the at least two connectors together.

5. The LED ceiling frame light of claim 1 comprising four of the connectors, wherein the connectors are positioned about the LED ceiling frame light to minimize or reduce a packaging volume of the LED ceiling frame light, upon the disconnecting of the four connectors.

6. The LED ceiling frame light of claim 1 comprising a light transmissive cover or lens covering each of the longitudinal extending LED light strip.

7. The LED ceiling frame light of claim 6, wherein the light transmissive cover or lens has a light diffuser.

8. The LED ceiling frame light of claim 6, wherein the LED ceiling frame light is configured and disposed to shine a portion of light emitted by the longitudinal extending LED light strips toward the rectangular or square opening in the LED ceiling frame light.

9. An LED lighting system comprising the LED ceiling frame light of claim 1 and an electrical junction box configured to be held to the ceiling support grid and house an electrical junction of the LED ceiling frame light to a power source.

10. The LED lighting system of claim 9 comprising a clip configured to clip to an upward extending flange of the ceiling grid support and hold the junction box therewith.

11. The LED lighting system of claim 9 comprising an LED driver housed in the electrical junction box.

12. A method of mounting an LED ceiling frame light with a ceiling support grid comprising:
removing a ceiling panel from the ceiling support grid and forming a rectangular or square opening therein;
connecting at least two connectors together and forming an LED ceiling frame light having a first leg, a second leg, a third leg, and a fourth leg with a rectangular or square opening and a substantially planar upper surface;
laying flanges extending outwardly from the legs of the LED ceiling frame light on ceiling support grid flanges extending inwardly toward the rectangular or square opening in the ceiling support grid;
electrically connecting the LED ceiling frame light with a power source; and
laying a ceiling panel or other feature on the substantially planar upper surface of the LED ceiling frame light and holding the ceiling panel or other feature substantially in a plane of adjacent ceiling panels held in the ceiling support grid and covering the rectangular or square opening in LED ceiling frame light.

13. The method of mounting an LED ceiling frame light with a ceiling support grid of claim 12, further comprising laying the removed ceiling panel, or other ceiling panel or feature, on the substantially planar upper surface of the LED ceiling frame light.

14. The method of mounting an LED ceiling frame light with a ceiling support grid of claim 12, further comprising attaching and holding an electrical junction box to the ceiling support grid.

15. The method of mounting an LED ceiling frame light with a ceiling support grid of claim 14, further comprising electrically connecting the LED ceiling frame light to a power source and housing the electrical junctions in the electrical junction box.

16. The method of mounting an LED ceiling frame light with a ceiling support grid of claim 14, further comprising housing an LED driver in the electrical junction box.
